(19) United States
(12) Patent Application Publication
(10) Pub. No.: US 2013/0246117 A1
(43) Pub. Date: Sep. 19, 2013

(54) METHOD AND SYSTEM FOR PRODUCTION FACILITY PLANNING

(71) Applicant: XEROX CORPORATION, Norwalk, CT (US)

(72) Inventors: Eric Michael Gross, Rochester, NY (US); Jack Gaynor Elliot, Penfield, NY (US)

(73) Assignee: XEROX CORPORATION, Norwalk, CT (US)

(21) Appl. No.: 13/760,508

(22) Filed: Feb. 6, 2013

Related U.S. Application Data
(60) Provisional application No. 61/611,341, filed on Mar. 15, 2012.

(51) Int. Cl. G06Q 10/06

(52) U.S. Cl. CPC G06Q 10/0631
USPC 705/7.23; 705/7.12; 705/7.24; 705/7.25

(57) ABSTRACT

A print job planning system determines a current state of a print shop and a set of expected disturbances for the print shop. It uses the current state and the set of expected disturbances to determine a cost for anticipated work in progress associated with various actuations. It also identifies a minimum cost from the determined costs, along with an actuation that corresponds to the minimum cost. It may then generate a report of the actuation, generate a work schedule based on the identified actuation, and/or cause the identified actuation to be implemented by at least one print device of the print shop.

### RELATED APPLICATIONS AND CLAIM OF PRIORITY

This patent document claims priority to U.S. provisional patent application No. 61/611,341, filed Mar. 15, 2012. The disclosure of the provisional application is incorporated herein by reference in its entirety.

### BACKGROUND

In a production facility such as a print shop, it is helpful to have an effective operations control system. However, achieving effective control is often difficult due to the complexity of most production systems. Stochastic behavior, non-linearity, discrete event behavior, and other disturbances can all affect operations of a production facility and make analysis difficult. The lack of a comprehensive approach to operations control can result in control systems that are ad-hoc and not robust, far from optimal, and in some cases result in worse performance than open loop.

This document describes methods and systems that address some or all of the problems described above.

### BRIEF DESCRIPTION OF THE FIGURES

FIG. 1 illustrates an example of a production environment.

FIG. 2 is a graphic illustration of how a change in an actuator may affect an output in a production environment.

FIG. 3 illustrates an example of various elements of a production environment, represented as a fluid flow diagram for purpose of illustration.

FIG. 4 is a flowchart showing steps that a production facility planning system may implement.

FIGS. 5-8 illustrate examples of simulation results.

FIG. 9 is a block diagram showing elements of a computing device.

### SUMMARY

In an embodiment, a print job planning system determines a current state of a print shop and a set of expected disturbances for the print shop. It uses the current state and set of expected disturbances to determine a cost for anticipated work in progress associated with various actuations. It also identifies a minimum cost from the determined costs, along with an actuation that corresponds to the minimum cost. It may then generate a report of the actuation, generate a work schedule based on the identified actuation, and/or cause the identified actuation to be implemented by at least one print device of the print shop.

In some embodiments, determining the cost for each actuation may include determining a cost for each of a standard time component and a non-standard time component, wherein each of the overtime component and non-overtime component are assigned a different weight.

In some embodiments, determining the minimum cost may include applying one or more constraints to a cost function such that a sum of actuations that any print device in the print shop may encounter in a single time period does not exceed a value corresponding to full utilization. In other embodiments, determining the minimum cost may include determining an accumulated demand for a product produced by the print shop, and imposing a constraint on a cost function that requires print shop output to equal or exceed the accumulated demand.

In some embodiments, determining the cost for each actuation may include using a cost function to determine the cost, wherein the cost function comprises one or more of the actuators modified by a weighting factor, wherein the weighting factor corresponds to one or more conditions of the print shop during a time period associated with the set of expected disturbances. In some embodiments, the cost function also may include one or more of the following constraints: a production rate boundary, a work in progress level boundary, or a boundary on a sum of actuations received at any given point in time.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For purposes of the discussion below, a “computing device” refers to a device that includes a processor and tangible, computer-readable memory. The memory may contain programming instructions that, when executed by the processor, cause the computing device to perform one or more operations according to the programming instructions. Examples of computing devices include personal computers, gaming systems, televisions, and portable electronic devices such as smartphones, personal digital assistants, cameras, tablet computers, laptop computers, media players and the like.

A “print device” refers to a device capable of performing one or more functions, operations and/or services on a print job. For example, a print device may provide print-related services for one or more print jobs. A print device may include a printer, multi-function device or other similar equipment that is capable of printing an image on a label.

A “print job” refers to a logical unit of work that is to be completed for a customer by a print shop. For example, a print shop order may be a request from a customer to print, collate, and cut, staple and/or bind a document or set of documents. A job may include one or more print jobs from one or more clients. Although the disclosed embodiments pertain to print jobs, the disclosed methods and systems can be applied to jobs in general in other production environments, such as automotive manufacturing, semiconductor production and the like.

A “print shop” refers to an entity that includes multiple document production resources, such as printers, cutters, collators and the like. A print shop may be a freestanding entity including one or more print-related devices. Examples include a printing service provider, or it may be a document production group within a corporation or other entity, such as a work area that contains one or more printers. Additionally, a print shop may communicate with one or more servers by way of a local area network or a wide area network, such as the Internet, the World Wide Web or the like.

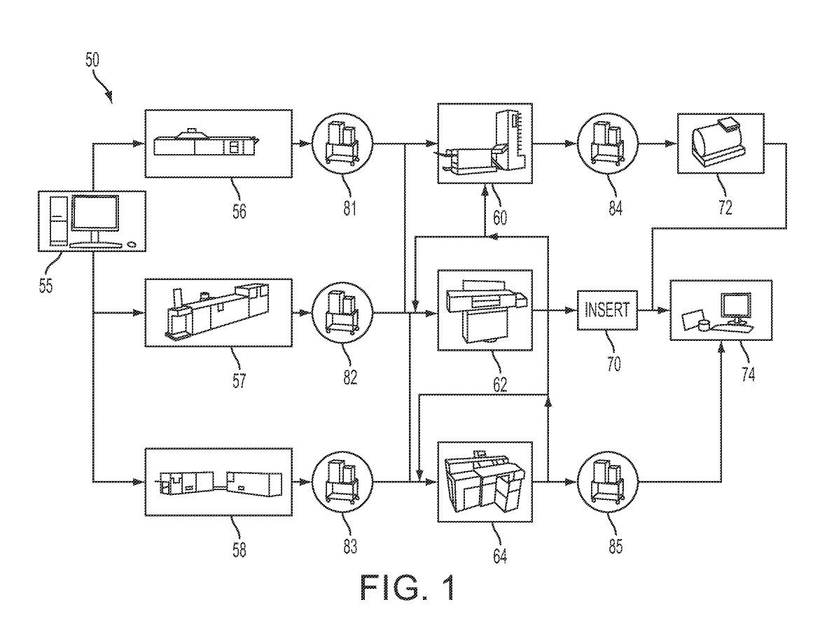

FIG. 1 shows an example of a production environment 50, in this case, elements of an example of a print shop. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85. Although the disclosed embodiments pertain to document production systems, the disclosed methods and systems can be applied to production systems in general.

This document describes a comprehensive, systems level approach to production control, whether in manufacturing or business process systems, that builds on a Rolling Horizon Planning (RHP) methodology. RHP is also known as Model Predictive Control (MPC). In the embodiments described below, control decisions are determined that optimize a cost function that penalizes variations from desired set points over a future time horizon. To handle issues common in manufacturing and business process environments such as overtime and the existence of multi-functional machines, the RHP approach is adapted in novel ways. In some embodiments, shop floor personnel may maintain the model (i.e. keep it “evergreen” and use it to embody the knowledge that is quantitative), as well as modify the cost criteria weights or terms to suit their particular needs. Although the examples below describe the use of the methods and systems in connection with a print shop, the approach is widely applicable to other manufacturing or business process environments.

Production facilities are often required to make operational control decisions in stochastic, complex, and constrained environments. Questions such as what product to make, in what quantity, when, and how, all must be addressed in some form. In the methods and systems discussed in this document, RHP is a controller incorporating feedback that uses both a system model and any set of constraints to predict the process outputs over a future time horizon.

The system may consider various factors or sets of factors. Example factors include: (1) a current state of the production facility; (2) expected future disturbances for the facility (which are events that originate from outside of the facility, or which the facility operators do not control, such as the receipt of new print jobs); and (3) actuations (which are events that one or more operators control, such as a selection of which device(s) will be used to process a job).

In an embodiment, the system may employ a processor to determine (such as via quadratic programming) a sequence of actuations that minimizes a quadratic cost function over a receding horizon. In some embodiments, the basic process may include the following steps: a first actuation is applied, the horizon is displaced by one sampling instant, and the process is repeated.

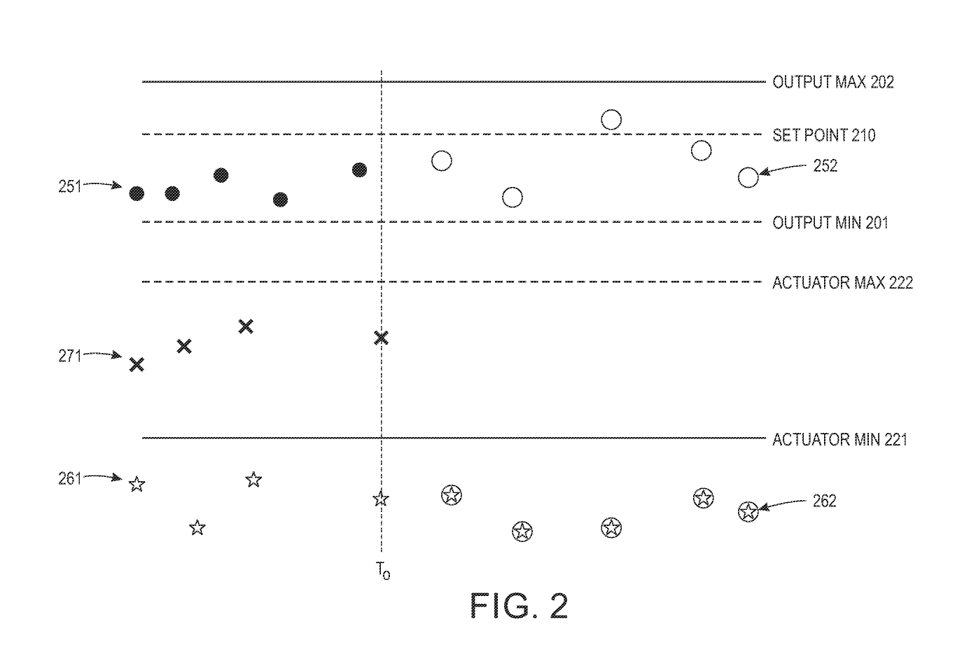

This process is shown in FIG. 2 for a single input/single output system. FIG. 2 is a graphic illustration of how a change in an actuator may affect an output in a production environment over time. As shown in FIG. 2, events that have occurred (past events) appear to the left of vertical line T₀, while predicted or planned future events appear to the right of vertical line T₀. Output measurements are represented by circles. Solid circles (e.g., 251) represent past measurements, and empty circles (e.g., 252) represent planned or predicted measurements. Output measurements may be any measure of print job production, such as jobs produced, pages processed, time used, or other measures. The measurements may be device-specific, aggregate measurements of a whole print job or group of print shops, or some group of devices in between those two extremes.

In FIG. 2, output measurements vary between a minimum level 201 and a maximum level 202. As used in reference to FIG. 2, as well as the remainder of this description, the terms “minimum” and “maximum” refer to constraints that the system may set based on one or more criteria. In some embodiments, the “minimum” and “maximum” values may vary based on various criteria, such as a type of disturbance, a temporal limitation such as time of day or day of week, or other criteria. The set point line 210 represents a desired work in progress (“WIP”) level for jobs that are awaiting processing by one or more print devices, while the various points representing output show actual and/or projected WIP levels. The set point may be determined using any suitable criterion, such as a method using average WIP=(Throughput)×(Cycle Time). Other methods, including manual input, are possible.

The system also may identify known past disturbances (represented by stars, e.g., 261) and estimated future disturbances (represented by circled stars, e.g., 262). The system also may identify known past actuations (each represented by an “x”, e.g., 271) and estimated future disturbances (represented by circled stars, e.g., 262). Actuators may vary between a minimum level 221 and a maximum level 222. The embodiments below may determine what the future (i.e., after time T₀) should be based on the past correlations between disturbances, actuators and output.

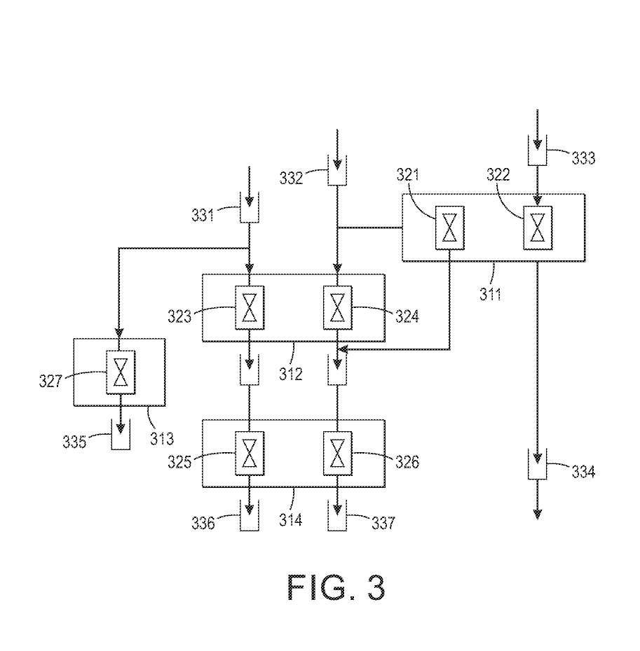

FIG. 3 illustrates an example of a production environment as a fluid flow diagram. In FIG. 3, the boxes (311-314) represent print devices, the valves (e.g., 321-327) represent product produced (e.g., output) from each print device. More than one valve in a box indicates that the device is multifunctional, such as a printer that can print either in a black and white mode or color mode and at possibly different rates. The tanks (e.g., 331-337) represent demand (i.e., work-in-progress that is in queue) for each print devices. The inputs to the facility (e.g., orders entering “tanks” 331, 332 or 333) are disturbances that affect the facility. Each customer order is converted into WIP that is awaiting processing by any of the print devices that are capable of processing that product. The shop has a job flow comprising three products, each of which has a unique input into the process (“tanks” 331, 332 or 333). For example, a first product (“Product A”) may be produced by card embossing and mounted on one machine 323, and then processed by insertion on another machine 325. Product B may be produced by card embossing on a first or second machine 324 or 321, with mount and insert processing on a third machine 326. Product C may be produced by card embossing, mount, and insert on a first machine 322. Inventories, represented by WIP, may be such that some are electronic in the form of print files, others are unfinished, and others are finished goods. The WIP may be one measure of the difference between input and output to each tank.

Each print device that has two or more possible outputs can only produce one type of output at a time. For example, one print device 311 may be capable of producing a black-and-white output or a color output, but not both at the same time.

The system may use a cost function, typically quadratic, to penalize WIP levels and determine the actuators (i.e., print device settings or print shop actions) that will minimize the cost for the WIP. A cost may be any measure of value, or a measure of resources required to complete one or more jobs. For example, cost may be measured in terms of money (e.g., dollars and cents), time required, human resources required, consumables required, or similar value-based or resource-based measurements. The cost function may be required to consider one or more constraints, such as minimum and maximum production rates, prohibiting negative WIP levels, bounding the maximum WIP levels, or ensuring that the sum of the actuations at any given time of a multifunctional device never exceeds 100%. The cost function may be, for example:

$${min}_{u ( k \vert k ) , … u ( m - 1 + k \vert k ) , ɛ} ( {\sum }_{i = 0}^{p - 1} \{ {\sum }_{j = 1}^{{n}_{y}} {\vert {ω}_{i + 1 , j}^{WIP} ( \begin{matrix}{WIP}_{j} ( k + i + 1 \vert k ) - \\ {r}_{j} ( k + i + 1 )\end{matrix} ) \vert}^{2} + {\sum }_{j = 1}^{{n}_{u}} {\vert {ω}_{i , j}^{Δ u} Δ {u}_{j} ( k + i \vert k ) \vert}^{2} + {\sum }_{j = 1}^{{n}_{u}} \vert {{ω}_{i , j}^{u} ( \begin{matrix}{u}_{j} ( k + i \vert k ) - \\ {u}_{j target} ( k + i )\end{matrix} \vert}^{2} ) \} + {ρ}_{ɛ} {ɛ}^{2} )$$

where constraints may be:

0≦uⱼ(k+i|k)≦uⱼₘₐₓ(i)

Δuⱼₘᵢₙ(i)−εVⱼₘᵢₙ^{Δu}(i)≦Δuⱼ(k+i|k)≦Δuⱼₘₐₓ(i)+εVⱼₘₐₓ^{Δu}(i)

0≦WIPⱼ(k+i+1|k)≦WIPⱼₘₐₓ(i)+εVⱼₘₐₓ^{y}(i)

ε≧0, i=0, . . . ,p−1, and u is constant beyond control horizon to p.

In the equations above, the parameters are:
μⱼ=actuators (production rates),
nᵤ=number of actuators
μ_{jtarget}=desired actuator set points,
WIPⱼ=work in process levels (Outputs),
rⱼ=desired WIP levels (references),
p=a horizon or period of time,
ωᵢⱼ=weights that can vary over prediction horizon p,
ε is a slack variable for constraint softening, and
ρ_{ε} is a slack variable weight.

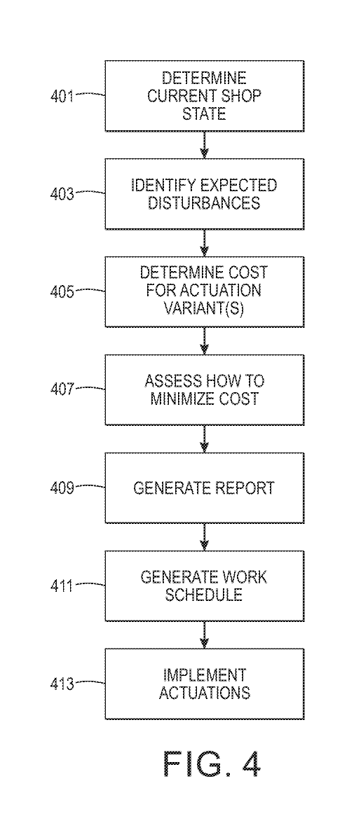

Thus, referring to FIG. 4, to plan for appropriate future actuations, the system may determine a current state of the print shop 401 and a set of expected disturbances for the print shop 403. As used in this paragraph and in the claims, the phrase “print shop” may refer to an entire print shop or some subset of the print shop, such as a print device or group of print devices. The system will determine the cost for one or more of the available actuation variants 405 and determine which actuation or actuations minimize the cost of the WIP 407. It may then generate a report which describes the actuation or actuations that minimize the cost 409, and/or it may implement one or more of the actuations that minimize cost 413. The “minimization” may be that which results in the least cost of the available options, or it may be that which results in the least cost so long as other criteria are also satisfied, or it may be that which is below a threshold level, or it may be some combination of the above.

In some embodiments, the cost function weights can be adjusted to penalize the actuation of overtime and/or outsourcing by the print shop. In other words, the weight ω can be used to penalize certain actuators depending on one or more conditions. This may achieved by receiving or automatically identifying actuators that are redundant, and penalizing only those actuators that correspond to overtime by non-zero weight terms. For example, if there are three shifts in the print shop, then different levels of weight can be assigned depending on which shift is in effect. For example, a standard weekday shift may be assigned a weight of ω^{μ}ᵢⱼ=zero, while a non-standard (e.g., evening) shift may be assigned a penalty or weighting factor of ω^{μ}ᵢⱼ=one, and a different non-standard (e.g.,) midnight shift may be more expensive than the evening shift and assigned a penalty or weighting factor of ω^{μ}ᵢⱼ=two. This can be accomplished, referring to the cost function above, by assigning non zero values to weights ω^{μ}ᵢⱼ to actuators μ₂ and μ₃ if they are respectively second shift and third shift. If third shift is more costly than second shift then presumably ω^{μ}ᵢ₂<ω^{μ}ᵢ₃. The weight on the day shift can be assigned a zero value if we do not choose to penalize that time period. Similarly, standard time may be assigned a first weight, and overtime assigned a different weight.

Thus, the actuators can be broken into conditional components, such as standard time and non-standard time components, and each component may be weighted differently in the cost calculation.

In some embodiments, product lateness may penalized by incorporating it as an additional constraint on a set of new state variables. For example, the state variables for a product may include the completed finished goods at time k, and the accumulated demand at time k−η, where η is the time interval after which product is due. The difference between these two variables may be required be greater than or equal to 0, otherwise the production system may be determined to have fallen behind in due dates. This can be expressed as, for any given time: Finished_Goods(k)−Demand_Accumulated(k−η)≧0. This is a constraint on state variables and can be incorporated into the RHP framework. The variable Finished_Goods(k) represents the level(s) in the tanks at the system output, and the accumulated demand is the integral of the demand at the input tanks.

Multifunctional machine behavior may be captured by imposing a constraint such that the actuations that share a given machine cannot at any time instant exceed 100% of utilization. As an example, referring to FIG. 3, device 312 can actuate two functions anywhere between fully off or fully on. For illustration consider two control actuators μ₂(k) and μ₃ (k) that are normalized to be between 0 (off) and 1 (full on). Device 312 in FIG. 3 is multifunctional in this example with two possible functions, and the functions cannot operate simultaneously. This constraint can be expressed as μ₂(k)+μ₃ (k)≦1, which can be readily incorporated into the quadratic programming problem formulation. Conforming to this constraint ensures that in actual implementation, over any specified time period the control actuation levels, μ₂(k) and μ₃, can be achieved on average.

In some embodiments, referring again to FIG. 4, the resulting outputs may be incorporated into a generated work schedule 411. This may be done so that the optimal actuations are on average approximate the computed values. Adjustment of controller weights and the upkeep of the model are the responsibility of the shop floor staff.

In some embodiments, a model may be developed and saved to a computer-readable memory. The model may include data corresponding to the available current states, disturbances, actuators and costs. In some embodiments, the model may be periodically updated with data such as actual WIP levels, print device production rates, and other actual data relating to print shop performance.

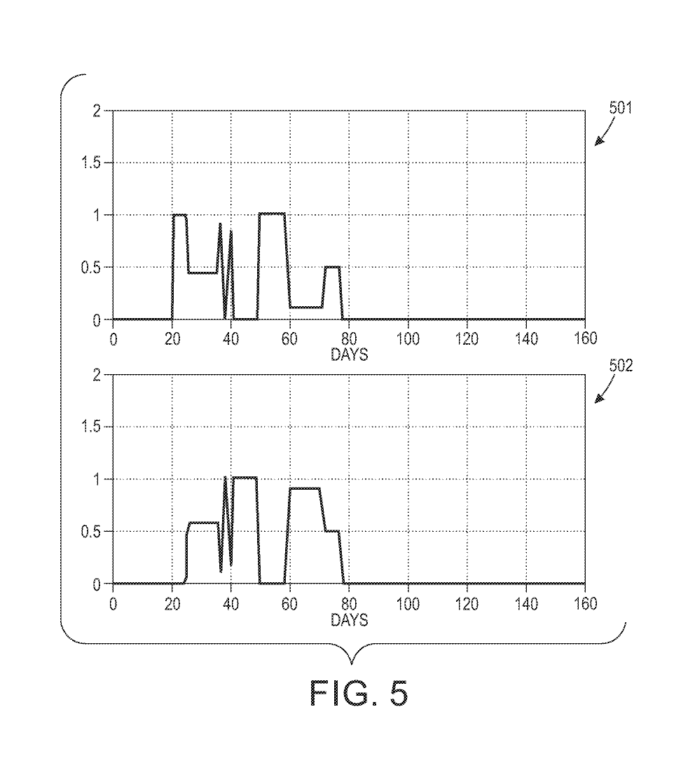

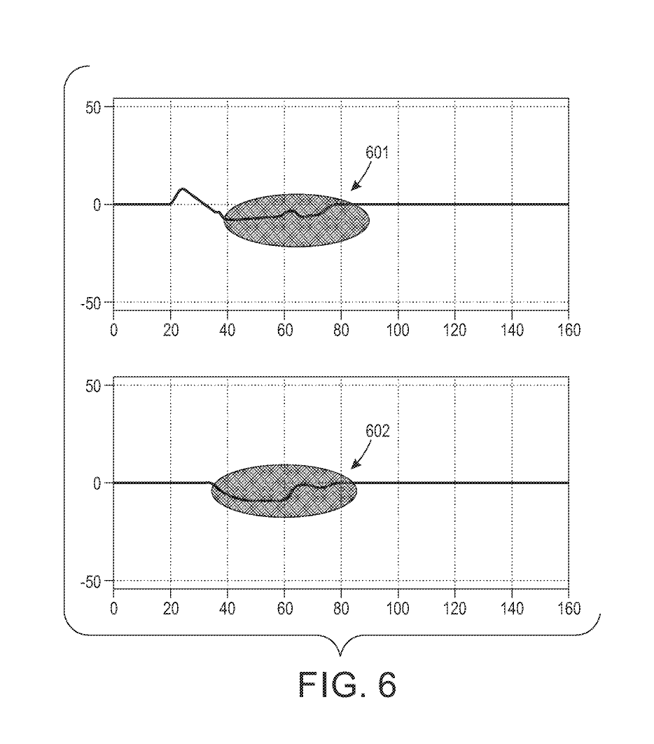

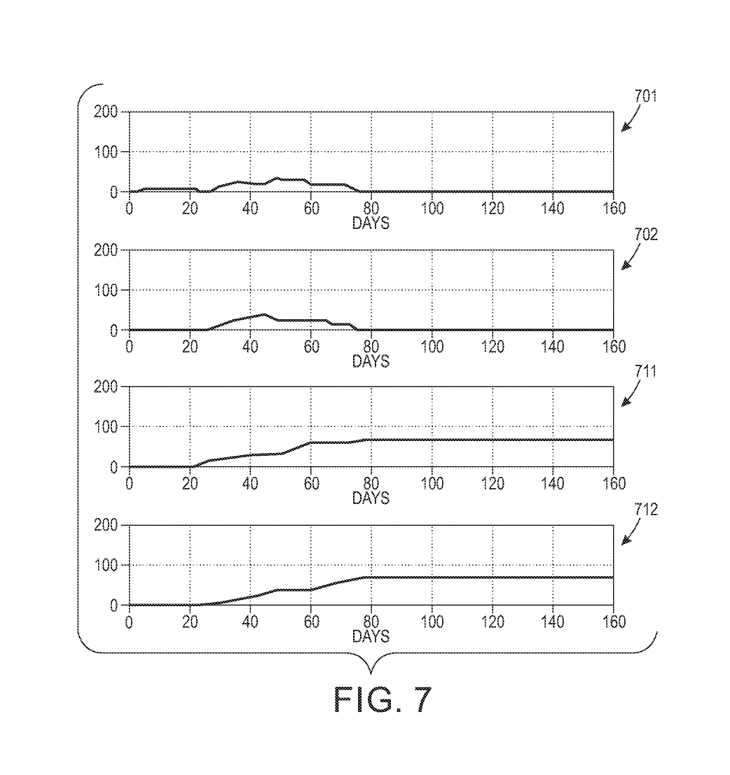

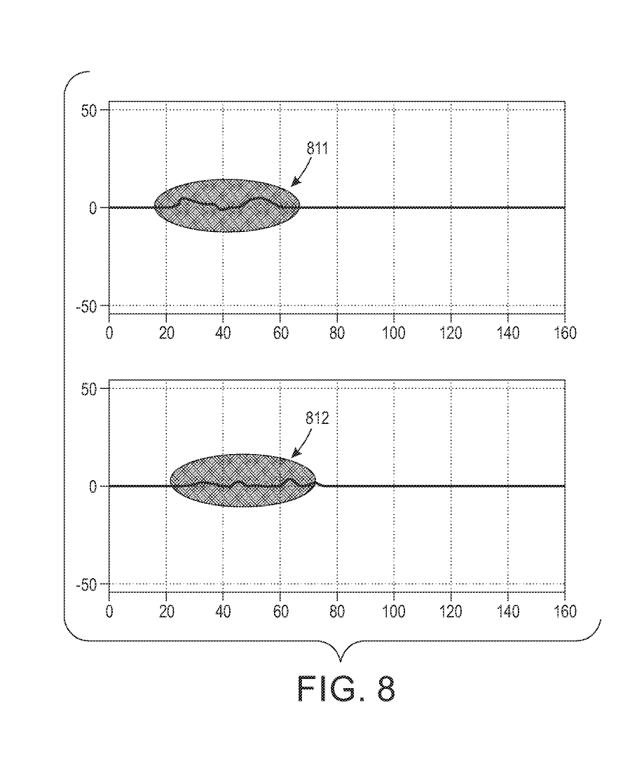

For a document processing case, FIGS. 5-8 show examples of simulation results to highlight the principles. Because of the large number of variables to display, only two variables and a single multi-functional machine are presented in these figures. In the results the effect of the multi-functional machine constraint, as well as values for job lateness and WIP levels can be observed. For example, FIG. 5 illustrates an example of actuations identified for two different products 501, 502 on a single multi-functional print device, with the constraint that the actuator must be ≦1. FIG. 6 illustrates examples 601, 602 where a lateness constraint has been violated for the two products, in this case the constraint being that lateness may not drop below zero. FIG. 7 illustrates examples of WIP levels 701, 702 and accumulated finished goods levels 711, 712 for the two products over time. FIG. 8 illustrates examples 811, 812 where the lateness constraint (lateness≧zero) has not been violated, in this case because of reduced demand levels. the constraint being that lateness may not exceed zero.

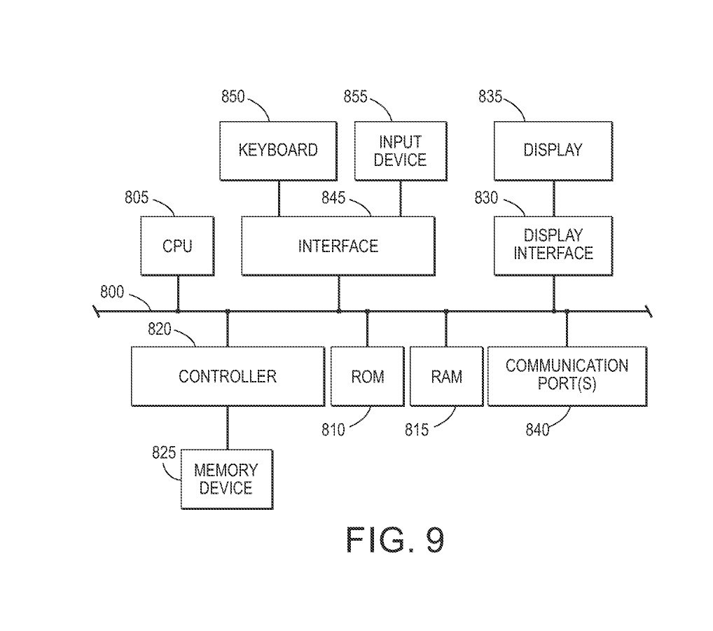

FIG. 9 depicts a block diagram of internal hardware that may be used to contain or implement program instructions, such as the portable electronic devices and servers described above. A bus 800 serves as an information highway to interconnect the other illustrated components of the hardware. CPU 805 is a processing unit for the system, performing calculations and logic operations required to execute a program. CPU 805, alone or in conjunction with one or more of the other elements disclosed in FIG. 9 is a processing device, computing device or processor as such terms are used within this disclosure. Read only memory (ROM) 810 and random access memory (RAM) 815 constitute examples of memory devices or processor-readable storage media.

A controller 820 interfaces with one or more optional tangible, computer-readable memory devices 825 to the system bus 800. These memory devices 825 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 810 and/or the RAM 815. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 835 may permit information from the bus 800 to be displayed on the display 835 in audio, visual, graphic or alphanumeric format. Communication with external devices, such as a printing device, may occur using various communication ports 840. A communication port 850 may be attached to a communications network, such as the Internet or an intranet.

The hardware may also include an interface 845 which allows for receipt of data from input devices such as a keyboard 850 or other input device 855 such as a mouse, a joystick, a touch screen, a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method comprising:
by a processor of a computing device, determining a current state of a print shop, and a set of expected disturbances for the print shop;
by the processor, using the current state and set of expected disturbances to determine a cost for anticipated work in progress associated with each of a plurality of actuations;
by the processor, identifying a minimum cost from the determined costs;
by the processor, identifying an actuation that corresponds to the minimum cost; and
by the processor, generating a report of the identified at least one actuation.

2. The method of claim 1, further comprising, by the processor, causing the identified actuation to be implemented by at least one print device of the print shop.

3. The method of claim 1, further comprising, by the processor, generating a work schedule based on the identified actuation.

4. The method of claim 1, wherein determining the cost for each actuation comprises:
determining a cost for each of a standard time component and a non-standard time component,
wherein each of the overtime component and non-overtime component are assigned a different weight.

5. The method of claim 1, wherein determining the minimum cost comprises applying one or more constraints to a cost function such that a sum of actuations that any print device in the print shop may encounter in a single time period does not exceed a value corresponding to full utilization.

6. The method of claim 1, wherein determining the minimum cost comprises:
determining an accumulated demand for a product produced by the print shop; and
imposing a constraint on a cost function that requires print shop output to equal or exceed the accumulated demand.

7. The method of claim 1, wherein determining the cost for each actuation comprises:
using a cost function to determine the cost, wherein the cost function comprises one or more of the actuators modified by a weighting factor, wherein the weighting factor corresponds to one or more conditions of the print shop during a time period associated with the set of expected disturbances.

8. The method of claim 7, wherein the cost function also comprises one or more of the following constraints:
a production rate boundary;
a work in progress level boundary; or
a boundary on a sum of actuations received at any given point in time.

9. A print shop planning system comprising:
a processor; and
a computer-readable memory containing programming instructions that, when implemented, instruct the processor to implement a print job planning process by:
determining a current state of a print shop, and a set of expected disturbances for the print shop;
using the current state and set of expected disturbances to determine a cost for anticipated work in progress associated with each of a plurality of actuations;
identifying a minimum cost from the determined costs;
identifying an actuation that corresponds to the minimum cost; and
generating a report of the identified at least one actuation.

10. The system of claim 9, further comprising:
a print device; and
wherein the instructions, when implemented, are also configured to implement additional functions of the print job planning process by causing the identified actuation to be implemented by the print device.

11. The system of claim 9, wherein the instructions, when implemented, are also configured to implement additional functions of the print job planning process by generating a work schedule based on the identified actuation.

12. The system of claim 9, wherein:
the instructions, when implemented, that are configured to determine the cost for each actuation comprise instructions to determine a cost for each of a standard time component and a non-standard time component, and
each of the overtime component and non-overtime component are assigned a different weight.

13. The system of claim 9, wherein the instructions, when implemented, that are configured to determine the minimum cost comprise instructions to apply one or more constraints to a cost function such that a sum of actuations that any print device in the print shop may encounter in a single time period does not exceed a value corresponding to full utilization.

14. The system of claim 9, wherein the instructions, when implemented, that are configured to determine the minimum cost comprise instructions to:
determine an accumulated demand for a product produced by the print shop; and
impose a constraint on a cost function that requires print shop output to equal or exceed the accumulated demand.

15. The system of claim 9, wherein the instructions, when implemented, that are configured to determine the cost for each actuation comprise instructions to:
use a cost function to determine the cost, wherein the cost function comprises one or more of the actuators modified by a weighting factor, wherein the weighting factor corresponds to one or more conditions of the print shop during a time period associated with the set of expected disturbances.

16. The system of claim 15, wherein the cost function also comprises one or more of the following constraints:
a production rate boundary;
a work in progress level boundary; or
a boundary on a sum of actuations received at any given point in time.

17. A method of planning activity by a print shop, comprising:
by a processor of a computing device, determining a current state of a print shop, and a set of expected disturbances for the print shop;
by the processor, using the current state and set of expected disturbances to determine a cost for anticipated work in progress associated with each of a plurality of actuations;
by the processor, identifying a minimum cost from the determined costs;
by the processor, identifying an actuation that corresponds to the minimum cost; and
generating a generating a work schedule based on the identified actuation; and
causing the identified actuation to be implemented by at least one print device of the print shop.

18. The method of claim 17, wherein determining the minimum cost comprises applying one or more constraints to a cost function such that a sum of actuations that any print device in the print shop may encounter in a single time period does not exceed a value corresponding to full utilization.

19. The method of claim 17, wherein determining the minimum cost comprises:
determining an accumulated demand for a product produced by the print shop; and
imposing a constraint on a cost function that requires print shop output to equal or exceed the accumulated demand.

20. The method of claim 17, wherein determining the cost for each actuation comprises:
using a cost function to determine the cost, wherein:
the cost function comprises one or more of the actuators modified by a weighting factor,
the weighting factor corresponds to one or more conditions of the print shop during a time period associated with the set of expected disturbances, and
the cost function also comprises one or more of the following constraints:
a production rate boundary;
a work in progress level boundary; or
a boundary on a sum of actuations received at any given point in time.
